(19) United States
(12) Patent Application Publication
(10) Pub. No.: US 2013/0194786 A1
(43) Pub. Date: Aug. 1, 2013

(54) Crystal beaded pumpkin and process of manufacture

(71) Applicant: Brian Earl Blatherwick, Georgetown (CA)

(72) Inventor: Brian Earl Blatherwick, Georgetown (CA)

(21) Appl. No.: 13/385,022

(22) Filed: Jan. 30, 2012

(51) Int. Cl. F21S 6/00; B05D 7/00; B05D 5/06

(52) U.S. Cl. 362/122; 427/105

(57) ABSTRACT

A novel crystal beaded pumpkin and process for making a same. An open topped transparent hollow shell member in the shape of a pumpkin or other holiday themed shape is internally coated with a thin layer of liquid acrylic resin. A plurality of color tinted transparent crystal beads are poured into the top of the shell member. The excess beads are then poured out of the shell member leaving a thin layer of beads coating the interior wall of the shell member. The shell member is then rotated in both the X and Y axis until the liquid acrylic resent has hardened causing the beads to be permanently attached to the inside wall of the hollow shell. An electrically powered light and light holder mounted in the interior of the hollow shell member causes the illumination of the color tinted crystal beads.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of novelty items and their manufacture and more specifically to a decorative crystal beaded pumpkin and its process of manufacture.

Decorative pumpkins have become a national symbol of the Thanksgiving holiday period. Traditionally, a real pumpkin is hollowed out by the user. Facial features such as a nose, eyes and mouth are then carved into the hollow shell of the pumpkin. A candle or electric light can be placed inside the hollow pumpkin which causes a distinctive glow at night.

A number of artificial pumpkins have been introduced into the marketplace which do not require the time and energy needed to carve a real pumpkin. These artificial pumpkins are typically blow molded from orange tinted polyethylene or styrene. Some of the patents that describe unique ways of creating artificial Halloween pumpkins include patents:

U.S. Pat. No. 6,555,188
U.S. Pat. No. 6,733,825
and patent application 2007/0114336.

However one method of constructing an artificial Halloween pumpkin has not been disclosed to date. This novel construction method results in a unique semi transparent Halloween pumpkin shape that is internally coated with a plurality of colored tinted crystal beads. This novel construction has not been seen or available in the marketplace as of the writing of this patent application.

### BRIEF SUMMARY OF THE INVENTION

The primary object of the invention is to provide a novel crystal beaded decorative pumpkin and the process for creating a crystal beaded decorative pumpkin or other holiday themed item.

Another object of the invention is to provide a novel process for creating a crystal beaded decorative pumpkin or other holiday item that is hollow, semi-transparent and can be lit from within by an electrically powered lighting device.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a crystal beaded pumpkin and process said pumpkin comprising: an open topped transparent, rigid hollow shell member in the shape of a pumpkin or other holiday themed shape, a plurality of color tinted transparent crystal beads, a high viscosity transparent, organic solvent based acrylic resin, an electrically powered light and light holder, an electrical power source, said high viscosity transparent organic solvent based acrylic resin applied in a thin layer to the inside surface of said hollow transparent shell member, said crystal beads poured into said shell member while said acrylic resin is still in a liquid state, said excess crystal beads poured out of the open top of said shell member leaving a thin layer of said crystal beads adhered to said transparent acrylic resin that is coating the inside of said hollow transparent shell member, said shell rotated in the X and Y axis while said acrylic resin is still in a liquid state, causing an even distribution of said crystal beads, said transparent acrylic resin becoming hard in approximately three minutes and causing said crystal beads to permanently adhere to the inside wall of said hollow shell member, and said electrically powered light and light holder mounted in the interior of said hollow shell member in a standard way for the purpose of illuminating said color tinted crystal beads.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the transparent hollow shell of the invention.

FIG. 2 is a perspective view of liquid resin being poured into the shell.

FIG. 3 is a perspective view of a person shaking and rotating the shell to cause even distribution of resin.

FIG. 4 is a perspective view of a person pouring in crystal beads.

FIG. 5 is a perspective view of a person rotating the shell containing beads.

FIG. 6 is a perspective view of a person removing excess beads.

FIG. 7 is a perspective view of the finished shell with beads in place.

FIG. 8 is a section view of the shell showing the internal construction.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

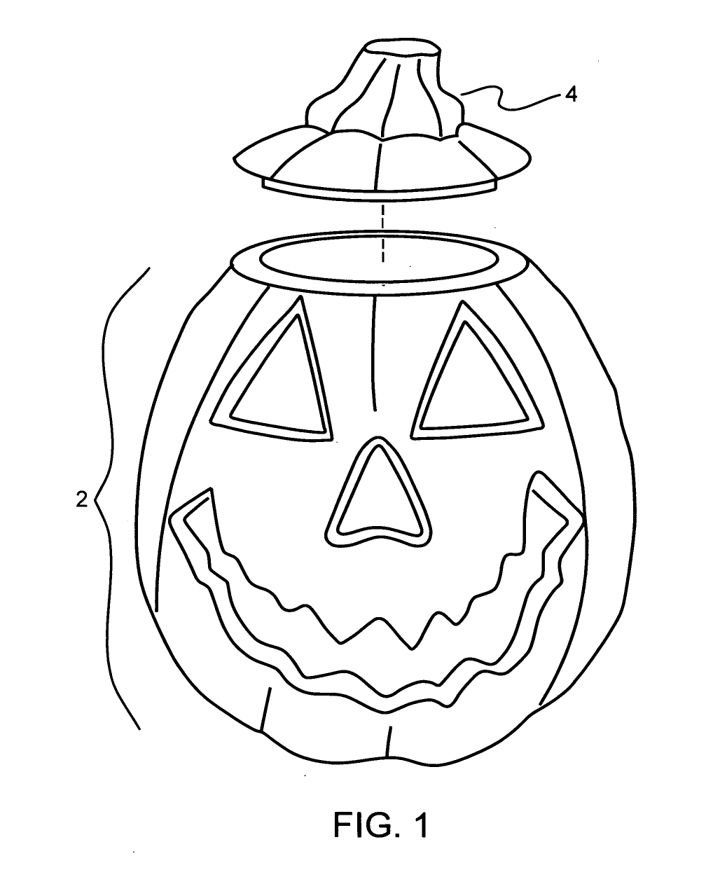

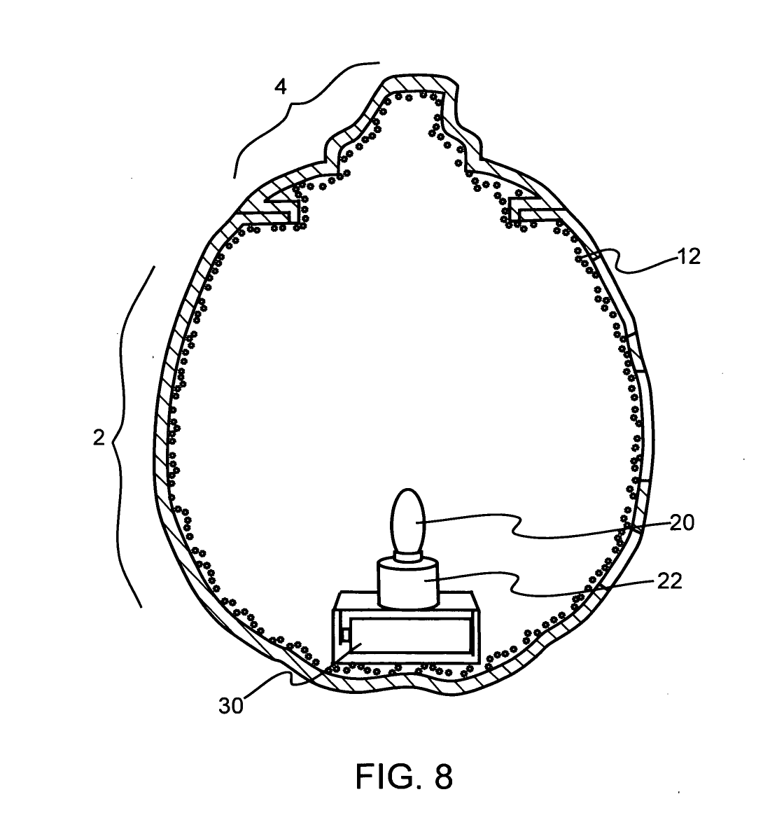

Referring now to FIG. 1 we see a perspective view of a hollow transparent, rigid shell in the form of a standard decorative pumpkin 2 and a standard pumpkin top lid 4. The pumpkin shell 2 includes the rendition of standard pumpkin features such as a mouth, nose and eyes. The entire shell 2 is made of transparent or semitransparent plastic such as transparent styrene or acrylic. Although the facial features represent a standard carved pumpkin design, the facial features in this shell 2 include a layer of plastic within each facial feature that preserves the uninterrupted wall quality of the shell as can be seen clearly in the side section view shown in FIG. 8.

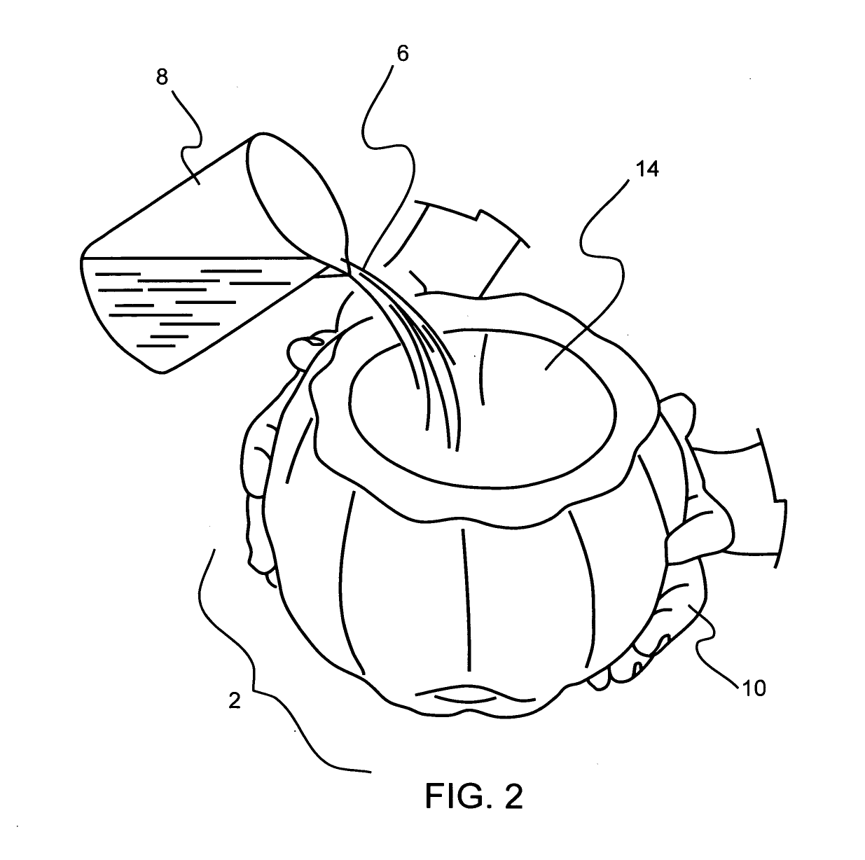

FIG. 2 shows a perspective view of the shell 2 while a viscous transparent organic solvent based acrylic resin 6 is being poured from a vessel 8 into the open top 14 of the shell 2 by the user 10.

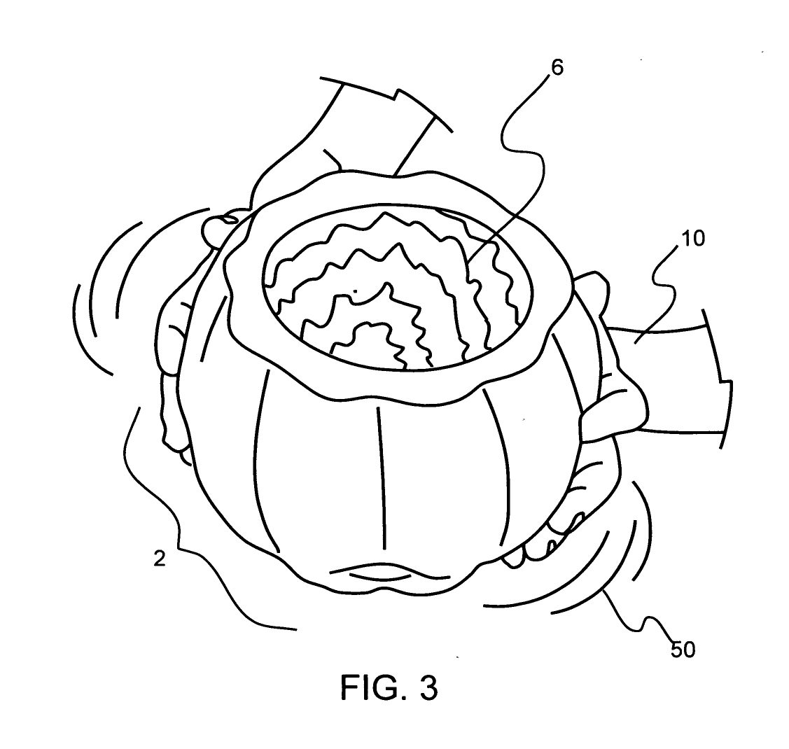

FIG. 3 shows the shell 2 being rotated in both the X and Y axis so that an even coating of resin 6 coats the inside wall of the shell 2. If there is excess resin 6 for the intended purpose, it can be poured out through the top opening 14.

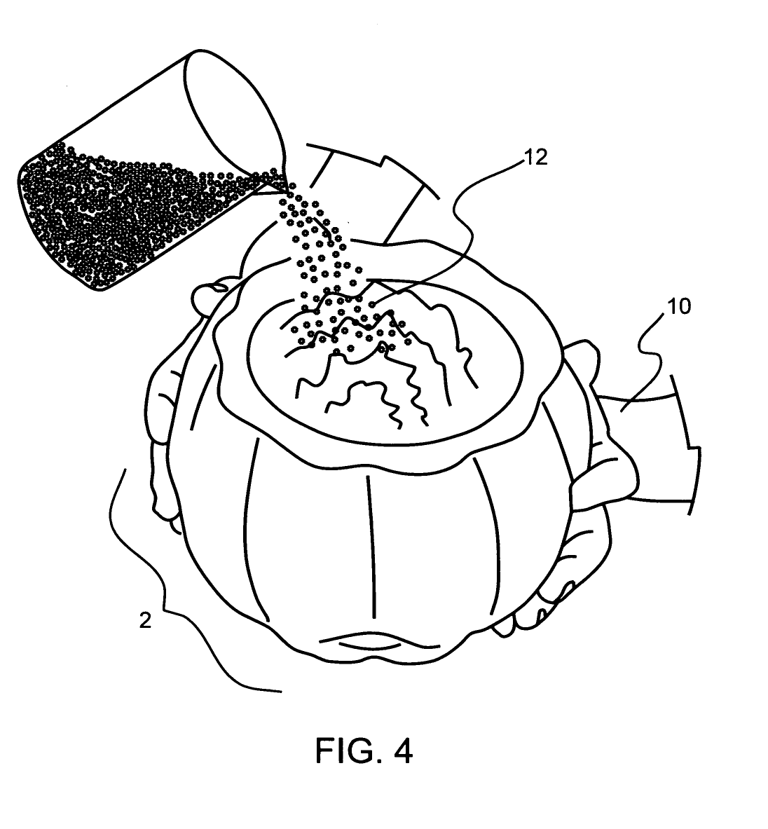

FIG. 4 shows a person pouring crystal beads 12 from vessel 10 into open top 14 of hollow shell 2.

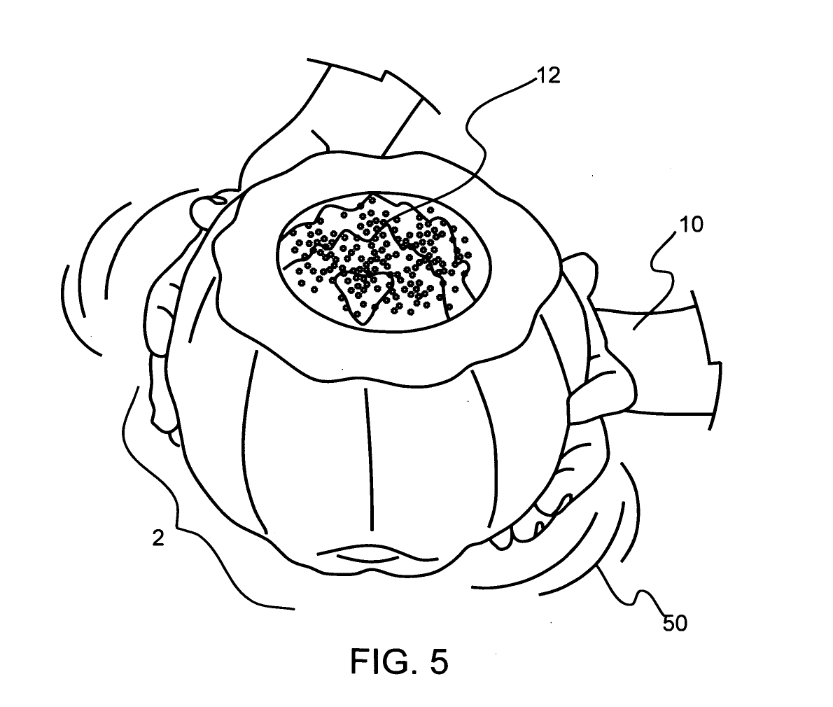

FIG. 5 shows a person rotating the shell in the X and Y axis so that an even layer of crystal beads 12 sticks to the still liquid resin on the inside walls of the shell 2. The crystal beads 12 can be made of transparent plastic or glass and are preferably tinted in a variety of colors. The process of rotation can be automated. This process closely resembles the rotational molding process however it does not require heat.

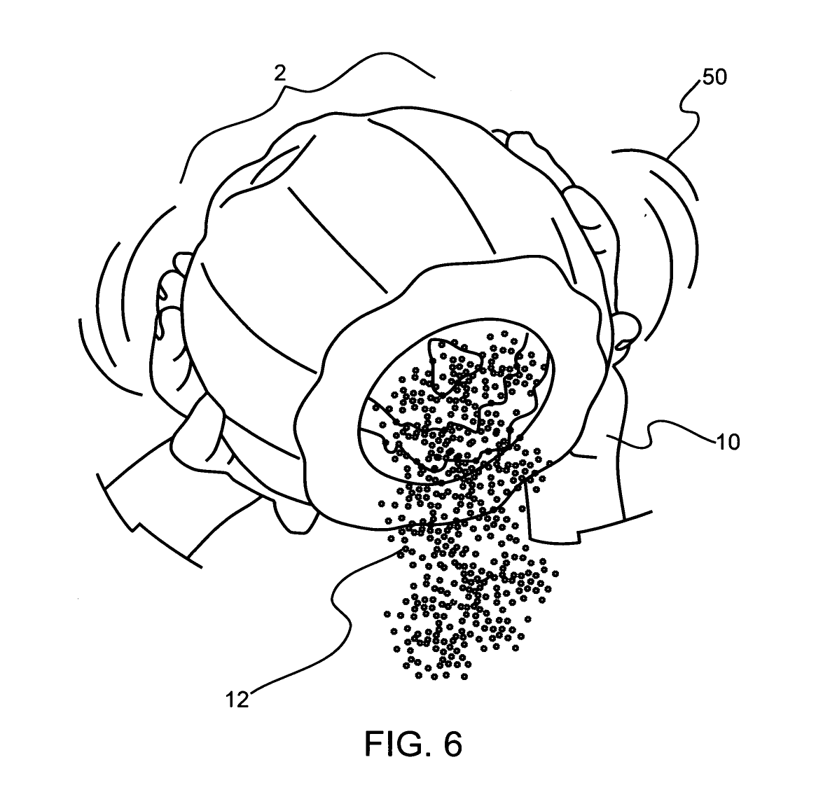

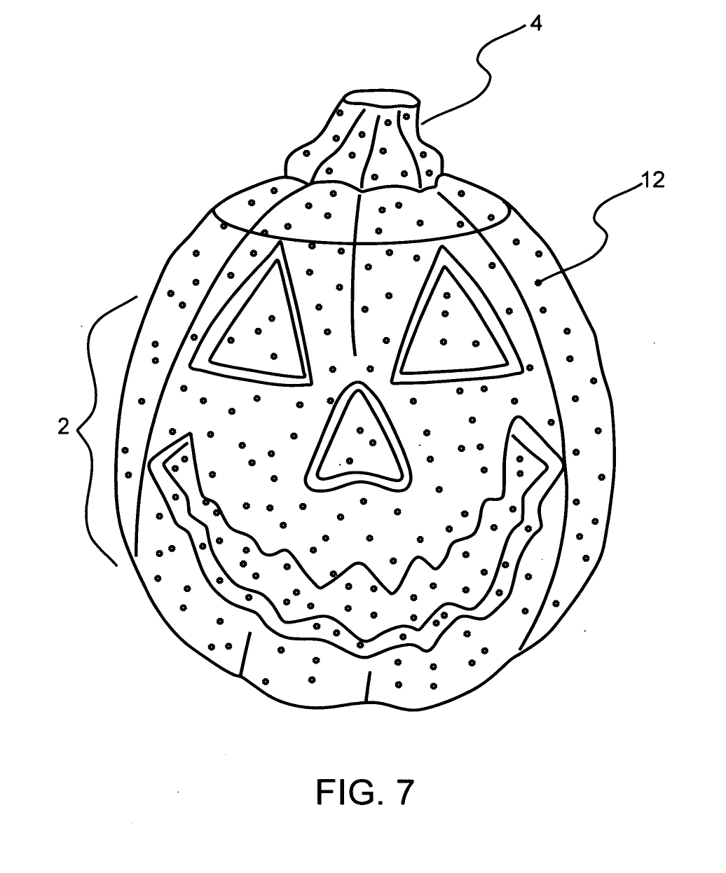

FIG. 6 shows the user 10 pouring out the excess crystal beads 12 leaving a thin layer of beads adhered to the acrylic resin 6. The resin 6 then hardens in approximately three minutes and the beads 12 are then permanently adhered to the inside wall of the shell 2 as shown in FIG. 7.

FIG. 8 shows a side section view of the invention as described by section line 30 in FIG. 7. The crystal beads 12 can be seen adhered to the inside walls of the shell 2. An electric lamp 20 and lamp holder 22 are mounted to the bottom of the shell 2 in a standard way. A battery power source 30 can power the lamp 20, or the lamp 20 can be powered by a standard wall plug and 120 VAC house voltage. The resulting crystal beaded pumpkin shape provides a novel Thanksgiving decorative item that glows with a multi colored faceted aura that is an appreciated addition to the holiday spirit. Obviously, other shell designs can be manufactured for other holidays such as a hollow snowman shape for Christmas or a hollow menorah shape for Chanukah. The crystal beads adhering to the inside wall of the shell can be one color, such as orange for the pumpkin shape or green for a Christmas tree shape. Or the beads can be multi colored for decorating the internal shells of items such as a Christmas star or cross or peace sign.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. crystal beaded pumpkin process comprising:
an open topped transparent rigid hollow shell member in the shape of a pumpkin or other holiday themed shape;
a plurality of color tinted transparent crystal beads;
a high viscosity transparent, organic solvent based acrylic resin;
an electrically powered light and light holder;
a standard electrical power source;
said high viscosity transparent organic solvent based acrylic resin applied in a thin layer to the inside surface of said hollow transparent shell member;
said crystal beads poured into said shell member while said acrylic resin is still in a liquid state;
said excess crystal beads poured out of the open top of said shell member leaving a thin layer of said crystal beads adhered to said transparent acrylic resin that is coating the inside of said hollow transparent shell member;
said shell rotated in the X and Y axis while said acrylic resin is still in a liquid state, causing an even distribution of said crystal beads;
said transparent acrylic resin becoming hard in approximately three minutes and causing said crystal beads to permanently adhere to the inside wall of said hollow shell member; and
said electrically powered light and light holder mounted in the interior of said hollow shell member in a standard way and powered by said standard electrical power source for the purpose of illuminating said color tinted crystal beads.
